(19) United States
(12) Patent Application Publication
(10) Pub. No.: US 2025/0042651 A1
(43) Pub. Date: Feb. 6, 2025

(54) Disposal and containment device for various types of waste and method of use

(71) Applicant: Claude A Burnett, Edmond, OK (US)

(72) Inventor: Claude A Burnett, Edmond, OK (US)

(21) Appl. No.: 18/228,465

(22) Filed: Jul. 31, 2023

(51) Int. Cl. B65F 1/14; B65F 1/12

(52) U.S. Cl. CPC B65F 1/14; B65F 1/125; B65F 2230/116; B65F 2250/1143; B65F 2250/1146

(57) ABSTRACT

A device to capture and temporarily contain filament and other fine loose waste for use in horticulture, fishing, and other related activities that involve the trimming and containment of such waste materials. The device has multiple uses and applications to various industries which deal in filament and fine line and net-type waste. It is designed to take up minimal space and mitigate disposal and containment difficulties for the user.

### CROSS REFERENCE TO RELATED APPLICATIONS

This application claims priority to U.S. Provisional Patent Application 63/393,569 filed on Jul. 29, 2022.

### BACKGROUND

### Field of Use

The subject matter in this patent application is a disposal and containment device for fine filament waste such as trellis or for plant waste for greenhouses, indoor, and outdoor grow facilities. The subject matter in this patent application can also be applied to securing many types of fine waste including but not limited to plastic trellis netting, other small filament netting, vines, wire, optical fiber, filament, fishing line and other similar items.

Trellis is a framed screen or net with a lattice pattern. It can be positioned vertically or horizontally to maximize available grow space and light penetration in plant grow operations. Trellis can be used indoors or outdoors. The concept is to bend and weave the plant shoots through the gaps in the pattern. Trellis allows the grower to manipulate plant growth and alter the pattern to best suit the plant or crop. As the plant is harvested the trellis material needs to be cut and/or removed. Cutting and disposing of the used trellis can be tedious and time consuming.

Other uses for this device could be for operations that utilize fine filament materials such as fishing line and netting that need to be cleaned up from an area and be disposed of or recycled.

The preferred embodiment of the device comprises elements needed to contain the trimmed trellis waste and maximize the productivity for the harvestor. This device is ideal for horticulture disposal into a device with a small footprint. This improves the productivity of harvest operations or any operations that utilize this type of material, such as fishing operations, and minimizes the space consumption during the trellis or net removal activity.

The preferred embodiment of the device allows for the trellis or other filament waste to be disposed of and contained.

The preferred embodiment of the device minimizes the waste volume associated with plant care or other similar activities, minimizes the time it takes to dispose of said wastes and improves productivity.

The preferred embodiment of the device mitigates safety and disposal issues involved.

The preferred embodiment of the device provides an ergonomic waste container.

The preferred embodiment of the device provides a waste disposal device for horticulture and other similar activities.

The preferred embodiment of the device provides a waste disposal device for activities involving filament, wire, netting, or other materials where containing waste is difficult or time consuming due to the elastic or non-elastic nature of linear or lattice-like materials.

The preferred embodiment of the device mitigates the struggle of containing the trellis waste.

The subject matter of this patent application is meant to apply to greenhouses, indoor and outdoor cannabis growing operations and other types of greenhouse environments or other types of horticulture growing and harvesting operations. Alternatively, it could be applied to other industries where net-like materials are used as well.

### Background of the Prior Art

The problem addressed with this invention is the challenging disposal and subsequent containment of trellis netting (also referred to as “trellis” in this document) and other filament-type waste within all types of horticultural operations and other operations in which filaments are used. Trellis comes in various sizes and consists of polymeric filament material and is used to support and/or constrain plants in commercial horticultural operations. Traditionally, the trellis netting is disposed by cutting the netting away from the plants and disposing of various sized pieces into a 5-gallon bucket or other sized containers. Due to the countless sizes and shapes of cut-out trellis and other filament wastes, the disposal process results in large volumes and rather unmanageable retention due to the natural tendency of the polymeric filaments to be flexible and not take on permanent deformation (i.e., spring-like). Additionally, some horticultural operations may prefer to dispose of the trellis on the ground/floor which creates safety hazards as well as creating wasted motion of retrieving the trellis, for a second or third time, before final disposal which negatively impacts productivity. Small scale and commercial fish operations also deal in filaments and filament type waste that is difficult to organize and dispose of.

Currently, there appears to be no technology available that solves this problem. No products like the one herein described are known to be available.

No available technology exists that has focused on the unique ergonomics or Lean horticulture techniques to minimize wasted motion of the operator/worker while harvesting or performing any other horticulture activities that could interact with this novel waste retaining device.

### DESCRIPTION

Disclosed herein is a device to retain filament-type waste. This device increases productivity by minimizing the excess motion associated with these operations (i.e., by physically contacting the single pieces of trellis or filament only once).

The invention is shaped and sized like a standard 5-gallon bucket to minimize space utilization and enable easy storage in space-restricted operations, particularly horticulture operations.

This filament retaining device solves this problem using a quasi-closed cylindrical container (1) with internal features for capturing the trellis filaments. The top of the cylindrical shape has a grippable portion (5) with 360 degrees of freedom. Additionally, the top of the cylinder consists of an elastomeric material with three radially orientated slits or openings (at 120 degrees) which provides an entrance to the device (i.e., entry point membrane (2)) The user inserts pieces of trellis waste into the “trellis trap” through the top end of the device or entry point membrane (2) and the elastomeric material provides partial resistance against the trellis filaments and thus prevents the trellis from exiting the device when the user withdraws their open/released hand. The interior of the device contains “comb-like” longitudinal structures (3). These “comb-like” features capture the filaments as they are released from the user's hand when inserted past the elastomeric entry membrane. The “comb” teeth are angled down and away from the entry point and in the direction of the user's hand upon inserting trellis. The angle of the “comb-like” teeth traps and/or retains the waste material in the device. The teeth provide an intrinsic compacter-type function (i.e., as more and more trellis pieces are added to the device and pushed downward) which reduces the volume of trellis for disposal. The exit end of the device consists of a polymeric lid (4) which is accessed occasionally to remove the compacted trellis for final disposal. Here again the direction of the angled comb teeth (3) (i.e., toward the exit end) facilitates easy removal of the naturally nested and compacted trellis from the exit end.

The objectives of the present invention are as follows: minimize the wasted motion associated with normal trellis disposal; minimizes the safety hazards involved in removing and disposing of trellis from the horticultural grow area; minimize the volume of trellis waste during the disposal process and in landfills; minimize the risk of wildlife entanglement in trellis net; and reduce the number of times the intermediate disposal containers are emptied into their final destination container.

The advantages of the present invention are as follows: minimal touch of the trellis material before final disposal; typical disposal into open containers results in large volumes of un-controllable “springy” trellis, requiring frequent hand compression of the trellis pieces into the waste container or manipulation of accumulated trellis into a knotted shape to maximize unused container space or more frequent final disposal; reduced motion of workers/operators due to design of the present invention which results in higher productivity during harvesting or any horticultural operation removing and disposing of cut trellis netting; and improved safety due to the elimination of disposing of trellis netting on the ground/floor, which creates a trip hazard.

The present invention is different than any other item on the market because no single device is present on the market to address horticultural operations in an organized, motion constrained manner where trellis material is disposed and currently, open ended containers are what are used for disposal.

Inventor's prior efforts to finalize the preferred embodiment of the invention: a) compacting the trellis by hand into the open container typically failed due to the trellis subsequently being pulled back out of the container with the hand due to the flexible nature of the trellis netting; b) the initial design with only the elastomeric entry point membrane with the three radial slits, but no inner teeth, was not effective in compacting the trellis as additional material was added to the device.

The present invention utilizes a quasi-closed cylinder shaped container configured and sized similar to a standard 5-gallon buckets (or other alternative container of varying sizes up to 55 gallon capacity) with an elastomeric entry point membrane (2) of 1/64″ to ½″ thickness and with 20-90 durometer hardness customary to the shore A scale (although various thickness and hardness may work); vertical comb-like structures (3) (with a quantity of 6 structures at 60-degree radial spacing, various quantities and angles are possible) made of polymer, metal or other suitable materials to capture and retain the trellis filament; the exit point lid (4) for easy removal of the naturally nested, waste trellis material into the final destination receptacle; an integral grab handle (5) around the top circumference of the device.

The overall dimensions are optimized for a user's hand or other grasping device to easily insert through the entry point membrane while holding the trellis waste, release the waste into the grasp of the comb-like structures and then withdraw the user's hand or other grasping device back through the entry point membrane with the trellis waste remaining inside the device.

Essential elements of the invention include the main body portion, an entry point membrane affixed along 1 end of the main body, a plurality of comb-like structures attached along the inner portion of the main body, an opening at the opposite end of the main body, and detachable piece that is affixed to the opposite end of the main body opening wherein the user can empty the trellis waste pieces.

An optional element of the device includes but is not limited to: an integral mounting lip (exit end) along the exterior circumference for incorporating an “endless” bagging system or larger capacity retention system. This would be used without the exit point lid in position and enable periodic evacuation of the waste materials (trellis) without the need for opening the exit lid.

Another optional element of the device includes but is not limited to: various overall height, length, and width of the main body portion (1) to accommodate various volumes of trellis waste or specific horticultural operations.

Another optional element of the device could include an attachment to secure the device to a ladder or other object.

Another optional element of the device includes but is not limited to: various configurations of the elastomeric entry point membrane (2) including the number and design of the slits.

The preferred embodiment of the device is made by: the cylindrical shape is rotomolded, 3D printed, or alternatively injection molded; the elastomeric entry membrane would be either 1) purchased as stock sheet material and subsequently water jet or hand-cut, or 2) compression molded; the polymeric exit lid will be either 1) rotomolded as part of the cylindrical shape and subsequently machined to the final shape, 2) 3D printed, or 3) injection molded; the vertical “comb-like” structures would be either 1) purchased as stock sheet material and subsequently water jet, or 2) injection molded, or 3) 3D printed; the vertical “comb-like” structures are inserted into the interior of the cylindrical shape; the polymeric exit lid snaps into position.

The preferred embodiment of the device will be utilized by user carrying the device anywhere they will be removing trellis material during harvest or other horticultural activity. It would be placed on the ground/floor or on an elevated surface. After cutting the trellis pieces from the suspended netting, the horticulture operator would stuff the piece/s into the “trellis trap” through the three radial slits in the entry point membrane and withdraw their empty, open hand. The membrane wipes the trellis netting from the operator's hand and secures it within the vertical comb-like structures of the container. Horticultural operator periodically completes a “full stroke/depth” with their hand into the inner body of the device to activate the “self-compacting” functionality.

All elements of the device can be modified to encompass additional interchangeable elements that would be relevant to horticulture activities and tasks.

All elements of the device can be modified to accommodate other types of filament-based waste.

The preferred embodiment of the device comprises: a cylindrical body component (1); and entry point membrane (2); a plurality of comb-like structures (3); exit lid (4); visual alignment feature (10); grippable feature (5); exit lid (4) open grip (14); and corresponding snap feature (13).

A detailed description of the preferred embodiment of the device is as follows: Cylindrical body component (1)—HDPE (high density polyethylene), LLDPE (Linear Low-Density Polyethylene) or alternative polymer, which is rotomolded and subsequently machined to the final size; entry point membrane (2)—elastomer, which is purchased in sheet configuration and either hand-cut or waterjet cut. Additionally, this component could be compression molded; vertical “comb-like” structures (3)—PVC (Polyvinyl Chloride), Polypropylene or alternative polymer, which is purchased in sheet configuration and either waterjet cut. Additionally, this component could be injection or compression/transfer molded; exit lid (4)—HDPE (high density polyethylene), LLDPE (Linear Low-Density Polyethylene), or alternative polymer, which is rotomolded simultaneously with the cylindrical component and subsequently machined to the final size; and visual alignment feature (10)—depression in the grippable feature (5) to provide quick visual or tactile identification/location of the exit lid's open grip (14) and corresponding snap feature (13) for opening the exit lid. Optional handles may be affixed to the main body (1) component either oriented horizontally or vertically.

Assembly of the device is described as follows: the cylinder (1) is placed on a table with the top facing up; then the entry point membrane (2) is placed on top retention lip (8) while aligning the matching holes; the entry point membrane is constrained by a polymeric retention ring (11) and fasteners (15); the cylinder (1) is placed on a table with the top facing down; the top alignment stud of each vertical “comb-like” structures (3) is inserted into the alignment hole(s) in the top retention lip (8) so the comb teeth are angled toward the exit end; each vertical “comb-like” structure is flexed sufficiently to engage the two alignment studs (7) (exit end) into the alignment holes in the bottom or exit retention lip (9); next the exit point lid (4) is affixed to the cylinder body with a stainless steel or other type dowel in the hinge feature (12); and lastly, the exit point lid with integrated open grip (14) is snapped into position on the cylinder body's snap feature (13).

Alternative embodiments of the device include but are not limited to (a) metal components instead of polymers, (b) other orientation or configuration of the trapping comb-like structures or are located differently along the longitudinal axis of the main body portion of the device, (c) and/or the shape of the main body portion could be any type of polygonal shape other than cylindrical. Additionally, the entry point membrane (2) and the comb-like structures (3) could be a stand-alone assembly where the elements could be applied to a standard off-the-shelf 5-gallon type bucket or similar open-ended container. Under this design, the assembly could be snapped or screwed into the bucket for use of collecting trellis waste, however, the waste would have to be removed manually from the open end of the bucket or alternatively a hole would have to be cut into the closed or opposite end of the bucket or similar open-ended container. Additionally, the spacing between the comb teeth (cantilever) or humps (protrusion) could be variable along the axis of the comb (i.e. tight teeth/hump spacing at the entry point and wider teeth/hump spacing at the exit point). It could also be separate components that are inserted into the container, or it could be those “comb-like”/“camel-back like” features being incorporated into the container itself.

An alternative embodiment is described as follows: this embodiment includes an “insert assembly” for use inside of buckets and provides the same functionality. This assembly is comprised of the following: a “top ring” to perform similar function as the top retention lip (8), a plurality of vertical “comb-like” structures (3), a separate component referred to a “bottom ring” with similar function as bottom or exit retention lip (9), the entry point membrane (2), the retention ring (11) and stainless steel self-tapping screws.

The alternative embodiment is assembled as follows: the component referred to as the “bottom ring” is placed on a horizontal surface, the bottom end of a plurality of vertical “comb-like” structures (3) is inserted and secured to the “bottom ring” so the comb teeth pointing down and inward, the entry point membrane (2) is placed on “top ring” and the retention ring (11) is placed on top of the entry point membrane and the screw holes are aligned with the holes in the entry point membrane, and then the stainless steel self-tapping screws are inserted through the retention ring, through the entry point membrane and through the “top ring”; at this point the sub-assembly (“top ring”, membrane, retention ring and screws) are positioned, aligned and screwed into the top end of the vertical “comb-like” structures (3) which are secured into the “bottom ring”.

It is an object of the present invention to minimize the labor wastes associated with normal horticulture management thus improving productivity. These labor wastes primarily involve excess movement of the workers and operators.

It is an object of the present invention to minimize the safety hazards involved in the process of cutting and removing trellis from the plants.

It is an object of the present invention to improve the placement and containment of waste materials.

It is an object of the present invention to provide a container for waste materials.

It is an object of the present invention to provide a container for trellis pieces.

It is an object of the present invention to mitigate the escape of waste materials.

It is an object of the present invention to mitigate the escape of the trellis pieces.

It is an object of the present invention to temporarily contain the waste materials.

It is an object of the present invention to temporarily contain the trellis pieces.

It is an object of the present invention to minimize the volume of trellis waste and other filament-based materials disposed of in landfills.

It is an object of the present invention to the risk of wildlife entanglement in trellis net and other similar waste materials.

It is an object of the present invention for the comb-like structures to hold the trellis pieces and other filament-based waste materials

It is an object of the present invention for the trap portion to mitigate the escape of trellis pieces and other filament-based waste materials.

It is an object of the present invention to contain different types of filaments, wire, or string-based waste.

As used herein, the term “filament-based waste materials” is meant to include but not be limited to fishing line, vines, wire, and most types of similar filaments or string like materials.

As used herein, the term “trellis” refers to a framework to be used as a support or guide for growing plants or vines. Trellis can be made of various materials including but not limited to filament, wire, string and other similar materials.

As used herein, the term “waste” refers to anything left over or superfluous, as excess material or by-products, remnants, or trimmings.

Although the invention has been described in detail with reference to several embodiments, additional variations and modifications exist within the scope of the spirit of the invention as described.

Although the disclosed invention has been described with reference to various exemplary embodiments, it is to be understood that these embodiments are merely illustrative of the principals and application of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from considerations of the specification and practice of the invention disclosed herein. It is intended that the specification and examples be considered as exemplary only, with a scope and spirit being indicated by the claims.

Finally, it is noted that, as used in this specification and the appended claims, the singular forms “a”, “an”, and “the,” include plural referents unless expressly and unequivocally limited to one referent, and vice versa. As used herein, the term “includes” or “comprising” and its grammatical variants are intended to be non-limiting, such that recitation of an item or items is not to the exclusion of other like items that can be substituted or added to the recited item(s).

### DESCRIPTION OF THE DRAWINGS

Drawing components:
(1) Main body or cylinder portion
(2) Entry point membrane
(3) Comb-like structures or grabbers (or trap features)
(4) Exit lid
(5) Grippable portion
(6) Alignment studs/holes (entry end)
(7) Alignment studs/holes (exit end)
(8) Top retention lip
(9) Bottom/exit retention lip
(10) Visual alignment feature
(11) Retention ring
(12) Hinge feature
(13) Snap feature
(14) Integrated open grip feature.
(15) Fasteners

### DESCRIPTION OF THE DRAWINGS

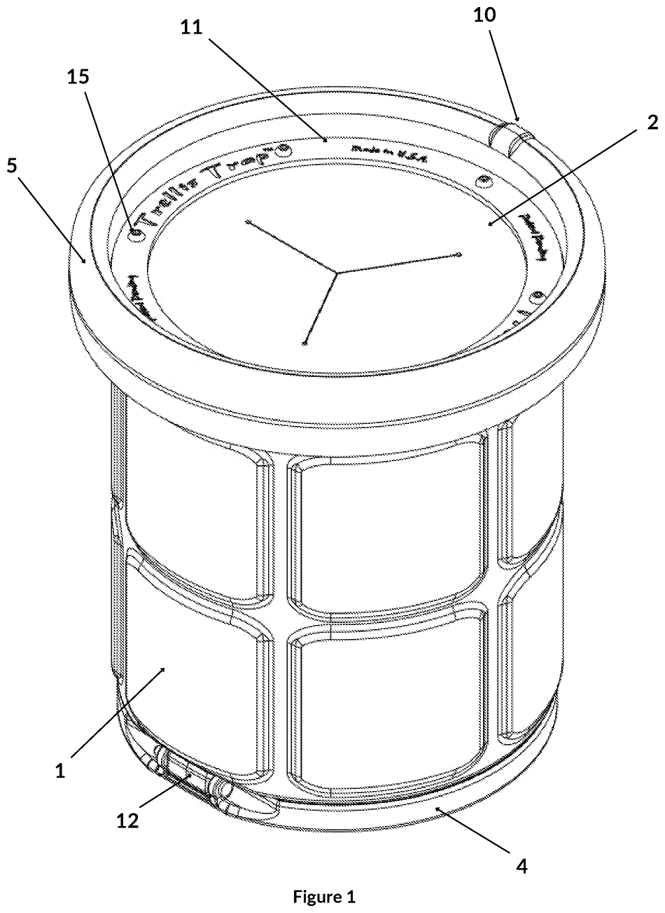

FIG. 1 shows a perspective view of the upper portion and side of the device.

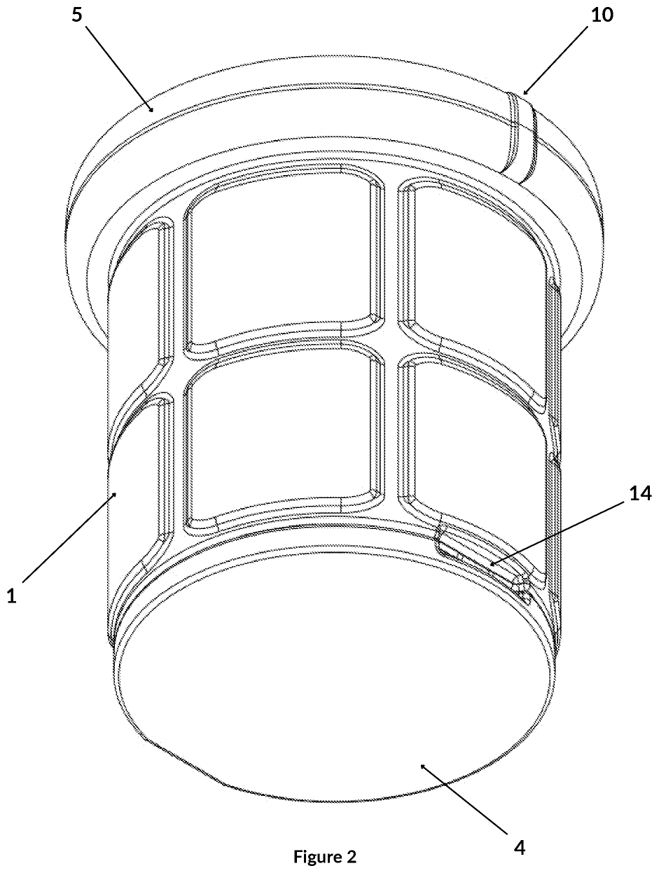

FIG. 2 shows a perspective view of the bottom or exit portion and side of the device.

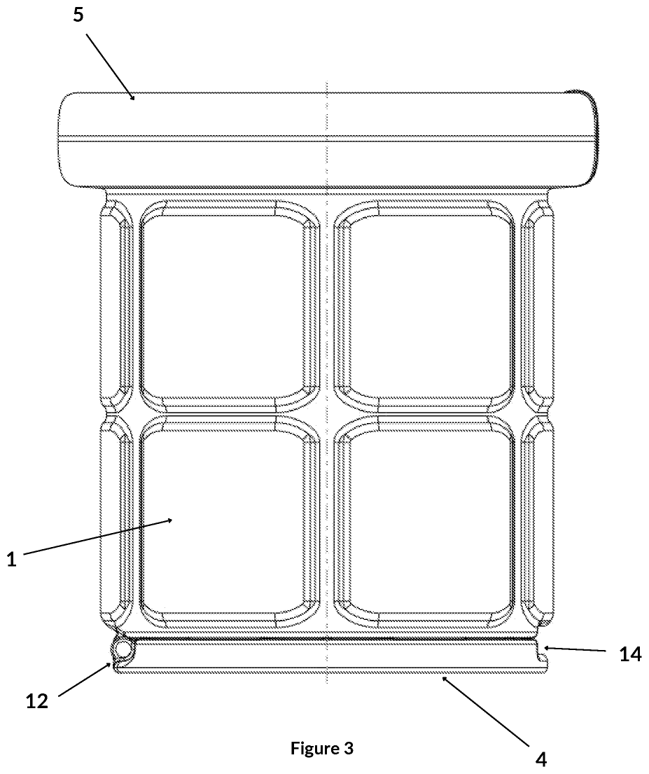

FIG. 3 shows a side view of the device.

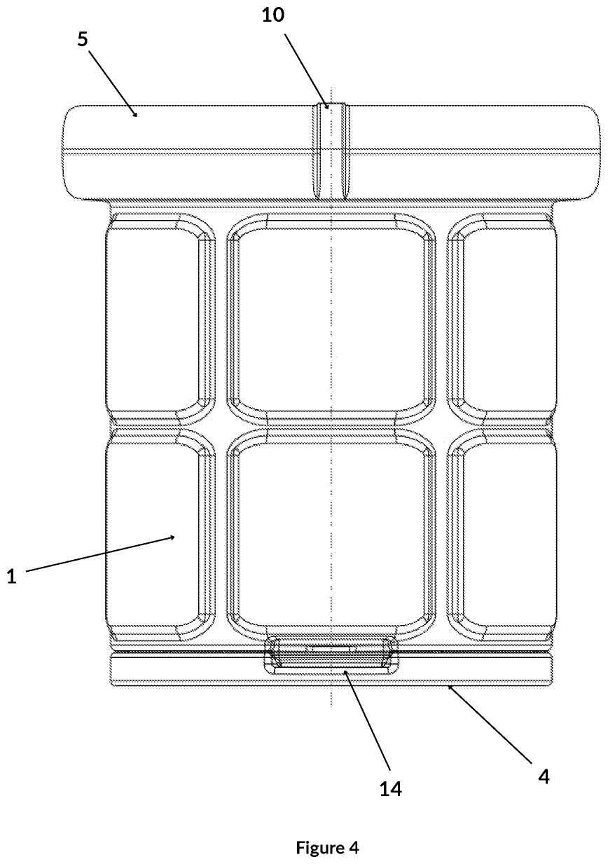

FIG. 4 is a side view of the device.

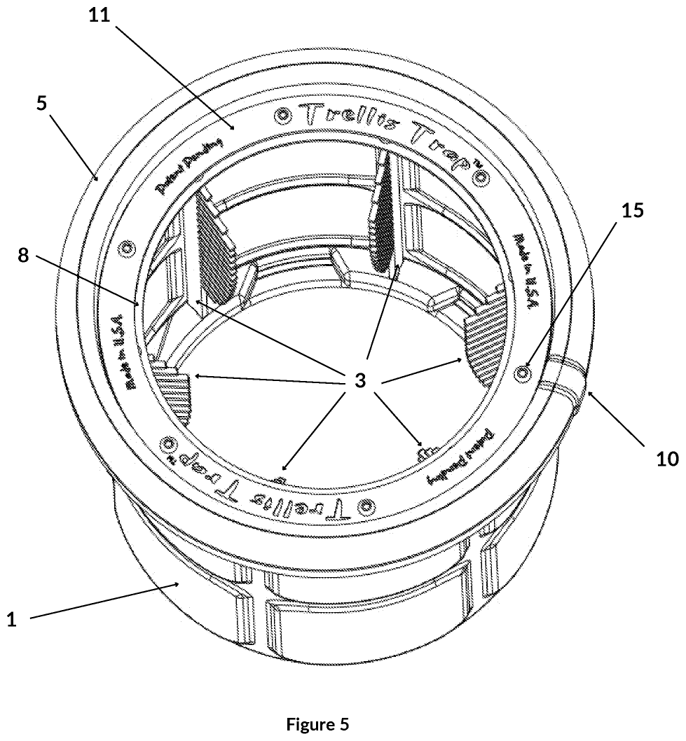

FIG. 5 shows an upper view of the inside of the device.

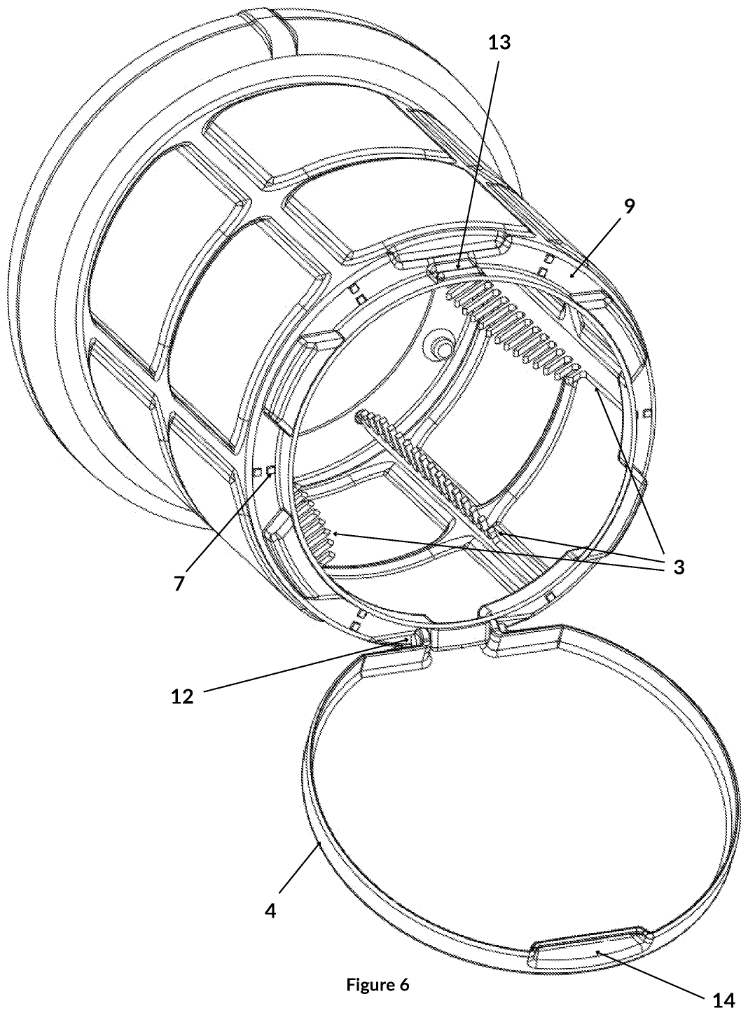

FIG. 6 shows a bottom view of the inside of the device.

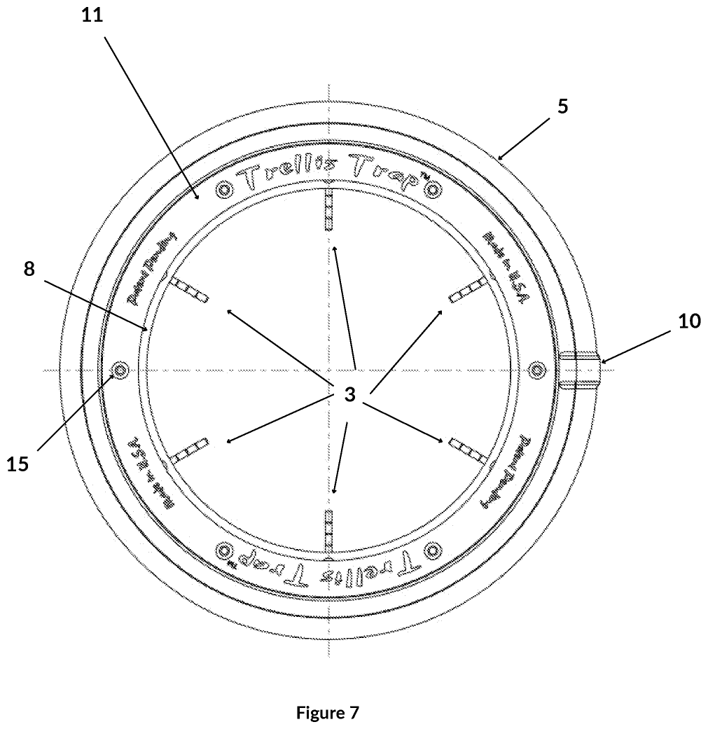

FIG. 7 shows a view of the inside of the device from an upper perspective.

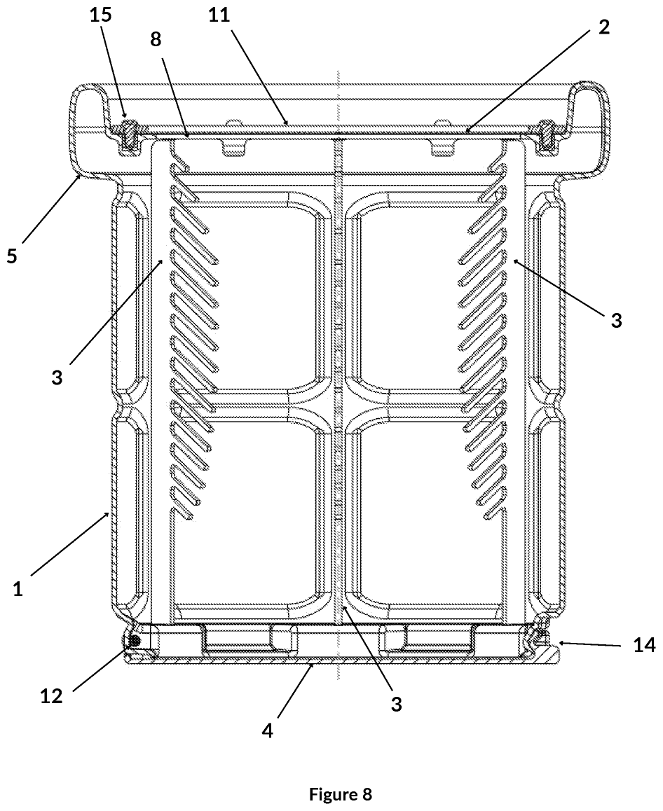

FIG. 8 shows a cross section of the device.

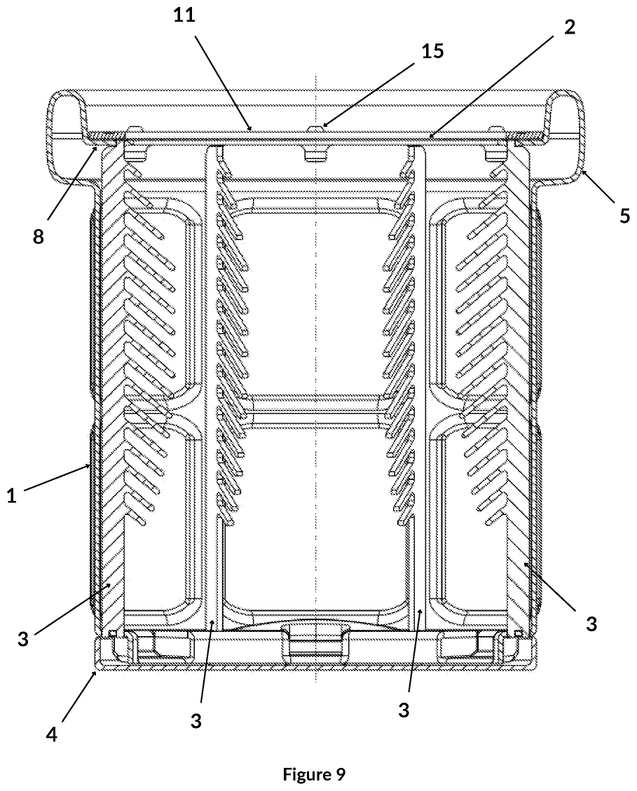

FIG. 9 shows a cross section of the device.

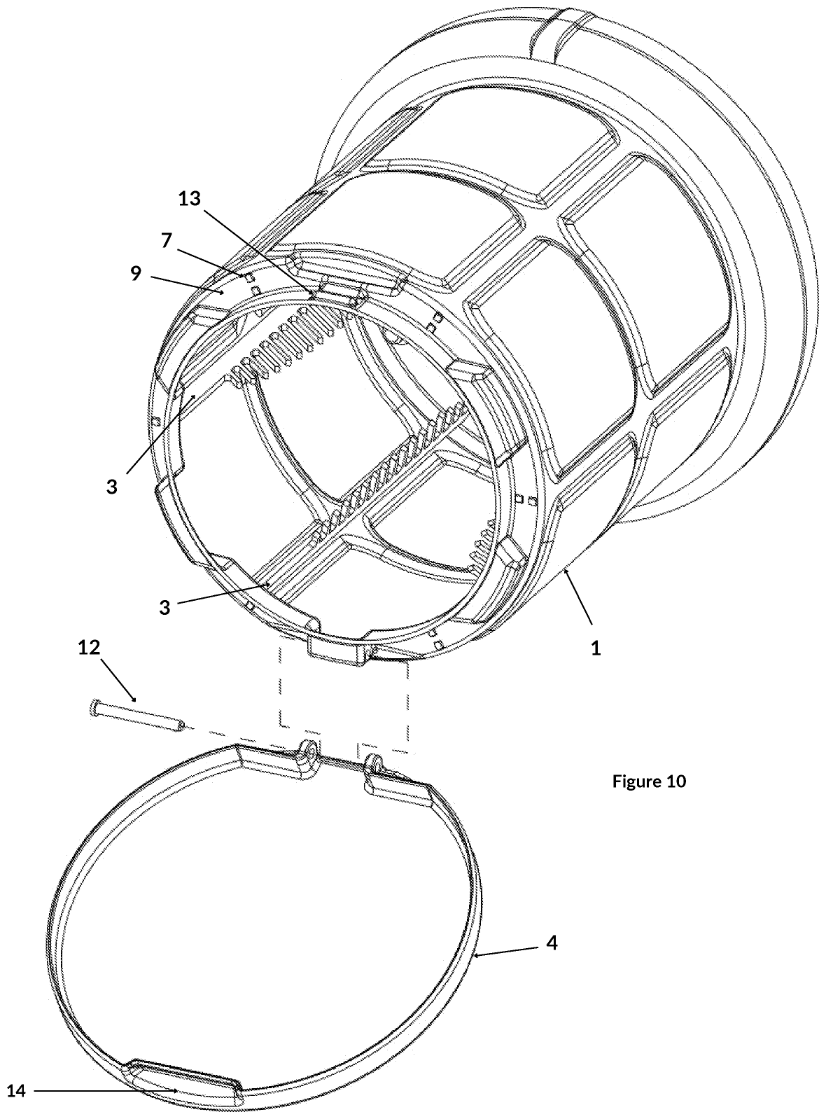

FIG. 10 shows a perspective view of the exit end of the device with a deconstructed view of the bottom lid.

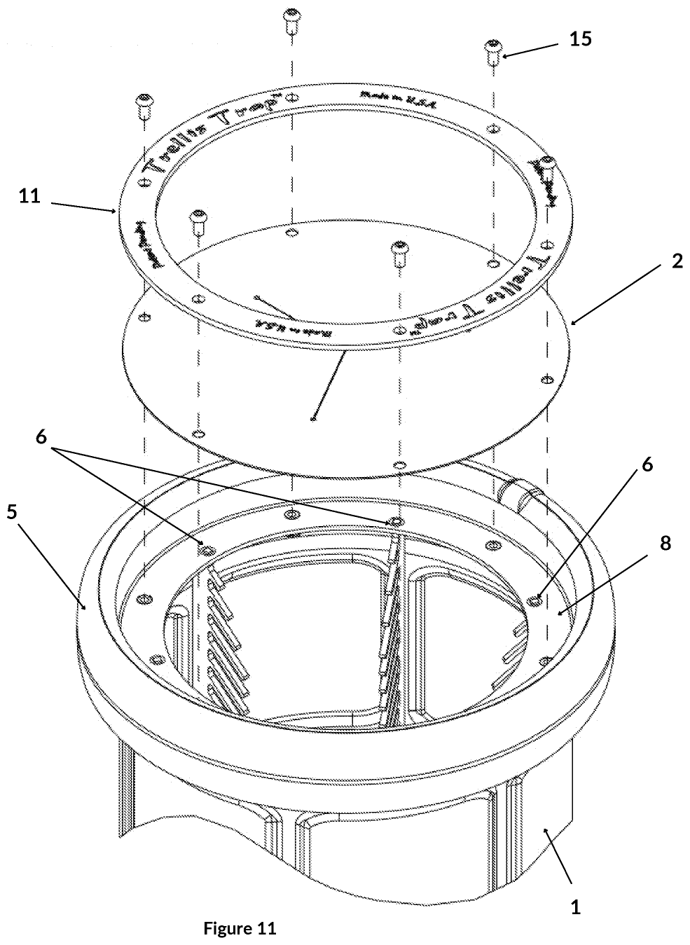

FIG. 11 shows an exploded view of the upper portion of the device.

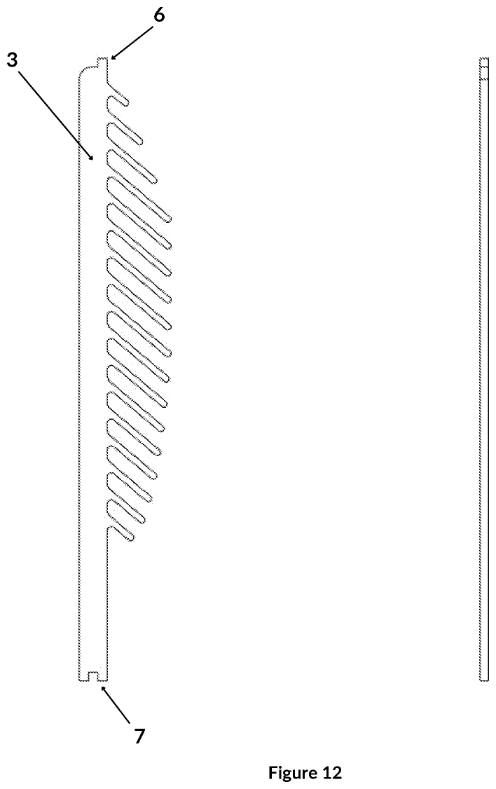

FIG. 12 shows the comb-like element portion of the device.

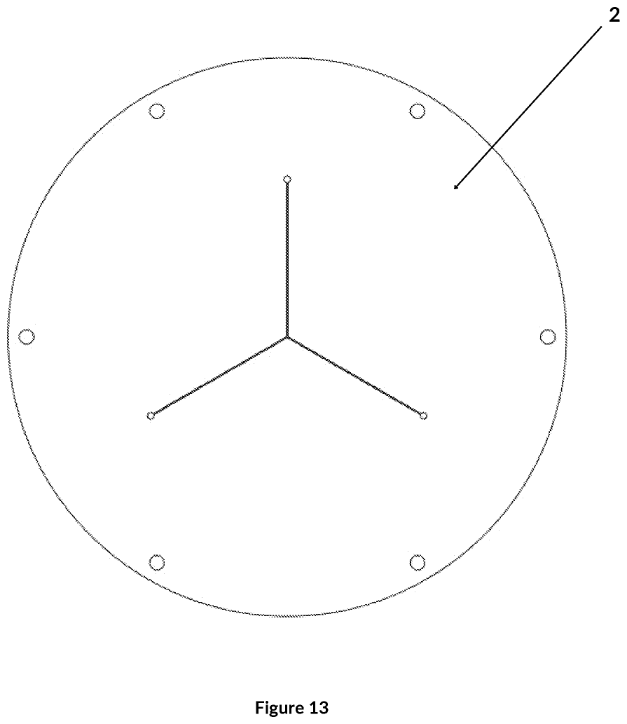

FIG. 13 shows the insertion membrane portion of the device.

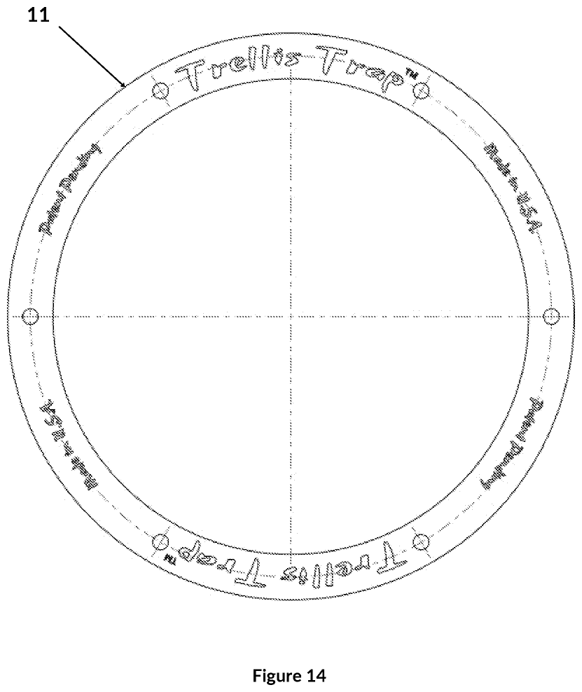

FIG. 14 shows the retainer ring portion of the device.

### DETAILED DESCRIPTION OF THE DRAWINGS

FIG. 1 shows a perspective view of the upper portion with entry point membrane (2), grippable feature (5), visual alignment feature (10), fasteners (15), retention ring (11), hinge feature (12) of the exit lid (4) and side of the main body (1) device.

FIG. 2 shows a perspective view of the exit lid (4), integrated open grip (14), main body (1), greppable portion (5), and visual alignment feature (10) of the top or entry portion.

FIG. 3 shows a side view of the device featuring the body portion (1), greppable portion (5), exit lid (4), hinge feature (12) and integrated open grip feature (14).

FIG. 4 is a side view of the main body portion (1), visual alignment feature (10), grippable portion (5), exit lid (4), and integrated open grip feature (14).

FIG. 5 shows an upper view of the device with the entry point membrane (not shown) removed further featuring the comb-like structures (3) attached to the inside of the body portion (1) top retention lip (8), grippable portion (5), retention ring (11), fasteners (15), and visual alignment feature (10).

FIG. 6 shows a bottom view of the device with the exit lid (4) open further showing the comb-like structures (3) on the inside of the device, snap feature (13) of the exit lid (4), hinge (12), integrated open grip feature (14), bottom retention lip (9) and alignment studs (7). FIG. 7 shows a top view of the device with the entry point membrane (not shown) removed featuring comb-like structures (3), grippable portion (5), top retention lip (8), visual alignment feature (1), retention ring (11), and fasteners (15).

FIG. 8 shows a side view cross-section of the device featuring comb-like structures (3), entry point membrane (2), retention ring (11), top retention lip (8), fasteners (15), grippable portion (5), body portion (1), hinge (12), exit lid (4), and integrated open grip feature (14).

FIG. 9 shows an additional side-view cross-section of the device featuring comb-like structures (3), entry point membrane (2), fasteners (15), retention ring (11), grippable portion (5), body portion (1), top retention lip (8), and exit lid (4).

FIG. 10 shows a perspective view of the exit end of the device featuring the main body portion (1), comb-like structures (3), exit lid (4), snap feature (13), alignment studs (7), exit retention lip (9), exploded view of the hinge (12), and integrated open grip feature (14).

FIG. 11 shows an exploded view of the upper portion of the device featuring securing element (15), retention ring (11), entry point membrane (2), grippable portion (5), top retention lip (8), alignment studs (6) and main body portion (1).

FIG. 12 shows a side and a rear view of the comb-like structure (3) featuring alignment studs (6 and 7).

FIG. 13 shows a top or bottom view of the entry point membrane (2) independent of the device.

FIG. 14 shows a top view of the retention ring (11) independent of the device.

What is claimed is:

1. A device for containment of filament type waste comprising: an at least one body portion, an at least one insertion portion, an at least one or more capture portion, an at least one containment portion and an at least one removal hatch or lid.

2. The device from claim 1 wherein said at least one body portion comprises an at least one or more openings at opposite ends.

3. The device of claim 1 wherein said at least one or more openings at opposite ends comprise an insertion end and a removal end.

4. The device of claim 1 wherein said at least one removal hatch is attached to said removal end.

5. The device of claim 1 wherein said at least one or more capture portions are attached distally to said at least one body.

6. The device of claim 1 wherein said at least one or more capture portions comprise an at least one or more plurality of retaining elements.

7. The device of claim 1 wherein said at least one or more plurality of retaining elements are angled toward said removal end.

8. A device for containment of filament type waste comprising: an at least one or more capture portion attachable to an at least one main body portion or frame.

9. The device of claim 8, wherein said at least one or more capture portion further comprises a plurality of retaining appendages.

10. A method of use of a device for containment of filament type waste comprising an at least one body portion, an at least one insertion portion, an at least one or more capture portion, an at least one containment portion and an at least one removal hatch or lid wherein a user inserts an at least one or more filament trimmings or waste through said an at least one or more insertion portion into said at least one body portion wherein said at least one or more capture portions secures said at least one or more trimmings which can then be compressed into said at least one or more containment portion wherein said at least one or more trimmings can be removed from said containment portion by opening said at least one or more removal hatch or lid and withdrawing said at least one or more trimmings.
